(19) United States
(12) Patent Application Publication
(10) Pub. No.: US 2005/0218689 A1
(43) Pub. Date: Oct. 6, 2005

(54) Anti-Glare Sunshade Combo\Dual Visor

(76) Inventor: Rodney Leo Edmonds SR., Park Forest, IL (US)

Correspondence Address: RODNEY EDMONDS, 23457 WESTERN AVE., # 2, PARK FOREST, IL, 60466, US

(21) Appl. No.: 10/906,755

(22) Filed: Mar. 4, 2005

Related U.S. Application Data
(60) Provisional application No. 60/556,701, filed on Mar. 29, 2004.

(51) Int. Cl. B60J 3/00

(52) U.S. Cl. 296/97.6

(57) ABSTRACT

A dual visor that are attached together, one normal existing visor with a ‘mirror & light,’ and another anti-glare sunshade visor.

### DESCRIPTION OF DRAWINGS

FIG. 1 is a perspective view of an Existing Normal Sun Visor ‘with mirror’.

FIG. 2 is a perspective view of an Anti-Glare Sunshade Visor.

FIG. 3 is a perspective view of an intact holding station that holds both visors together intact.

FIG. 4 is a perspective view of an intact holding station clip that holds both visors intact, But FIG. 2 will stay intact, and FIG. 1 can open, close and move in different positions.

FIG. 5 is a perspective view of an holding rod to keep FIG. 1 & 2 intact.

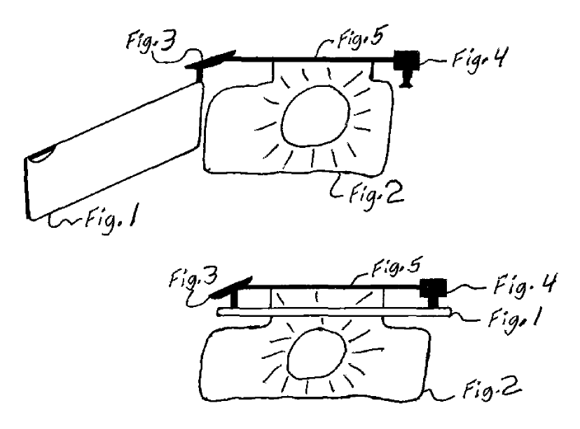

1. An Attach Anti-Glare Sunshade Dual Visor for vehicles.

2. An Attach Anti-Glare Sunshade Dual Visor of claim 1, which is made of tinted anti-glare sunshade PC-Polycarbonate Material.
